(19) United States
(12) Patent Application Publication
(10) Pub. No.: US 2024/0388548 A1
(43) Pub. Date: Nov. 21, 2024

(54) MESSAGE PROCESSING METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventor: Hongdou Wang, Shenzhen (CN)

(21) Appl. No.: 18/790,059

(22) Filed: Jul. 31, 2024

Related U.S. Application Data
(63) Continuation of application No. PCT/CN2023/092179, filed on May 5, 2023.

(30) Foreign Application Priority Data
Jul. 1, 2022 (CN) 202210774808X

(51) Int. Cl. H04L 51/04; A63F 13/87; H04L 51/063

(52) U.S. Cl. CPC H04L 51/04; A63F 13/87; H04L 51/063

(57) ABSTRACT

This application discloses a message processing method and apparatus, an electronic device, a storage medium, and a program product. The method comprises: causing to be displayed, by a first terminal device, a message control in a first screen of a first player object in a virtual scene, the message control being configured for editing a message that comprises a quick reply control, the quick reply control being configured for a quick reply to the message; and transmitting, in response to a transmission instruction for an edited message that has been edited by the first player object using the message control, the edited message to a second terminal device associated with a second player object, wherein the edited message comprises the quick reply control when displayed on the second terminal device displaying a second screen matching the first screen, and wherein a reply message is generated using the quick reply control when the second player object triggers the quick reply control.

### RELATED APPLICATION

This application is a continuation of PCT Application No. PCT/CN2023/092179, which claims priority to Chinese Patent Application No. 202210774808.X, filed on Jul. 1, 2022, both of which are incorporated herein by reference in their entirety.

### FIELD OF THE TECHNOLOGY

This application relates to the field of computer technology virtualization and human-computer interaction technologies, and in particular, to a message processing method and apparatus, an electronic device, a storage medium, and a program product.

### BACKGROUND

With the development of computer technology, electronic devices can achieve richer and more graphic virtual scenes. Users can obtain visual, auditory, and other aspects of virtualized feelings in the virtual scene, and can control a virtual object of one team to interact and match with a virtual object in another team in the virtual scene to obtain feedback.

In the related art, communication between player objects in a match in the virtual scene may be based on a fixed text set by a system. The player objects select and then send the fixed text. The accuracy of semantic expression of the fixed text is low. Alternatively, the player object may edit and send a message through a typing control provided by an application. The edited message is displayed in a chat region, and the other party needs to edit the message to reply. This makes the communication between the player objects in the match inefficient and the hardware resource utilization of the device low.

### SUMMARY

One or more aspects of this application provide a message processing method and apparatus, an electronic device, a computer-readable storage medium, and a computer program product, which can implement the editing of a message that comprises a quick reply control and a quick reply to a message in a match, improving the efficiency of communication between virtual objects and the hardware resource utilization of the device.

The various examples and aspects are described below.

One or more aspects described herein provide a message processing method, performed by a first terminal, the method comprising:
causing to be displayed, by a first terminal device, a message control in a first screen of a first player object in a virtual scene, the message control being configured for editing a message that comprises a quick reply control, the quick reply control being configured for a quick reply to the message; and
transmitting, in response to a transmission instruction for an edited message that has been edited by the first player object using the message control, the edited message to a second terminal device associated with a second player object,
wherein the edited message comprises the quick reply control when displayed on the second terminal device displaying a second screen matching the first screen, and wherein a reply message is generated using the quick reply control when the second player object triggers the quick reply control.

One or more aspects described herein further provide a message processing apparatus, comprising:
a first display module, configured to cause to be displayed message control in a first screen of a first player object in a virtual scene, the message control being configured for editing a message that comprises a quick reply control, the quick reply control being configured for a quick reply to the message; and
a message sending module, configured to transmit, in response to a transmission instruction for an edited message that has been edited by the first player object using the message control, the edited message to a second terminal device associated with a second player object,
wherein the edited message comprises the quick reply control when displayed on the second terminal device displaying a second screen matching the first screen, and wherein a reply message is generated using the quick reply control when the second player object triggers the quick reply control.

One or more aspects described herein further provide an electronic device, comprising:
a memory, configured to store executable instructions; and
a processor, configured to execute the executable instructions stored in the memory to implement the message processing method.

One or more aspects described herein further provide a non-transitory computer-readable storage medium, storing executable instructions, the executable instructions, when executed by a processor, implementing the message processing method.

One or more aspects described herein further provide a computer program product, comprising a computer program or an instruction, the computer program or the instruction, when executed by a processor, implementing the message processing method.

One or more aspects described herein have various technical improvements, some of which are described below.

A message control that can edit a message with a quick reply function is provided in a matching screen of a first player object. The first player object can perform customized editing of the message based on the message control. Because the player object performs the editing independently by choice, the edited message can accurately express the intention of the first player object. This improves the accuracy of semantic expression.

After the first player object edits and transmits the message, when the message is displayed on a terminal of a second player object, the message comprises a quick reply control configured for a quick reply to the message. In this way, the second player object is enabled to implement a quick reply to the message based on the quick reply control included in the message without the need to edit a reply message. This improves message reply efficiency, communication efficiency with the first player object, and utilization of hardware resources of a device.

### BRIEF DESCRIPTION OF THE DRAWINGS

FIG. 1A and FIG. 1B are each a schematic diagram of an example message processing screen in a virtual scene according to the related art.

FIG. 2 is a schematic architectural diagram of an example message processing system 100 according to one or more aspects described herein.

FIG. 3A and FIG. 3B are each a schematic structural diagram of an example electronic device that implements a message processing method according to one or more aspects described herein.

FIG. 4 is a schematic flowchart of an example message processing method according to one or more aspects described herein.

FIG. 5 is a schematic diagram of an example interaction rule for player objects according to one or more aspects described herein.

FIG. 6 is a schematic diagram of an example matching screen according to one or more aspects described herein.

FIG. 7A and FIG. 7B are each a schematic diagram of an example screen for selecting a message presentation manner according to one or more aspects described herein.

FIG. 8 is a schematic diagram of an example history message presentation screen according to one or more aspects described herein.

FIG. 9A to FIG. 9D are each a schematic diagram of an example message with a quick reply function according to one or more aspects described herein.

FIG. 10 is a schematic diagram of an example message reply screen according to one or more aspects described herein.

FIG. 11 is a schematic flowchart of an example message processing method according to one or more aspects described herein.

FIG. 12 is a schematic diagram of a screen of an example message processing method according to one or more aspects described herein.

FIG. 13 is a schematic diagram of an example player interaction in a tag team match game according to one or more aspects described herein.

FIG. 14 is a schematic diagram of an example message broadcasting by a server according to one or more aspects described herein.

### DETAILED DESCRIPTION

To make the objectives, technical solutions, and advantages of this application clearer, the one or more aspects described herein reference the accompanying drawings. The one or more aspects described herein are not to be considered as a limitation to this application. All other aspects obtained by a person of ordinary skill in the art without creative efforts shall fall within the protection scope of this application.

In the following description, the term “some aspects” describes subsets of all possible aspects, but it may be understood that “some aspects” may be the same subset or different subsets of all the possible aspects, and can be combined with each other without conflict.

In the following description, the involved terms “first” “second” or “third” are merely intended to distinguish between similar objects and do not represent a specific order of objects. It can be understood that “first” “second” or “third” can be interchanged in a specific order or sequential order if allowed, so that the aspects of this application described herein can be implemented in an order other than that illustrated or described herein.

Unless otherwise defined, meanings of all technical and scientific terms used herein are the same as those usually understood by a person skilled in the art. Terms used herein are merely intended to describe objectives of the one or more aspects described herein, and are not intended to limit the scope of the one or more aspects described herein.

Before the one or more aspects are described in detail, various terms used herein are described below.
(1) A client is an application running in a terminal and providing various services, such as a game client, an instant messaging client, or a video playing client.
(2) “In response to” is used for representing a condition or a state on which an operation to be performed depends. When the dependent condition or state is satisfied, one or more operations may be performed in real time or may have a specified delay. Unless otherwise specified, there is no restriction on an order of performing a plurality of operations to be performed.
(3) A virtual scene is a virtual scene displayed (or caused to be displayed or provided) when the application runs on the terminal. The virtual scene may be a simulated environment of the real world, or may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene, and the dimension of the virtual scene is not limited. For example, the virtual scene may include the sky, the land, the ocean, or the like. The land may include environmental elements such as the desert and a city. A user may control a virtual object to move in the virtual scene. The virtual scene may be a game, such as a multiplayer online battle arena (MOBA) game.
(4) Virtual object: images of various people and things that can interact in the virtual scene, or movable objects in the virtual scene. The movable object may be a virtual character, a virtual animal, a cartoon character, or the like, for example, a character or an animal displayed in the virtual scene.
(5) Player object: an object used in the virtual scene for controlling a virtual object to interact in a virtual scene, such as to fight in a game. A player object may control one or more virtual objects.

In the related art, the communication between player objects in a match in a virtual scene may be implemented in the following message processing manner:

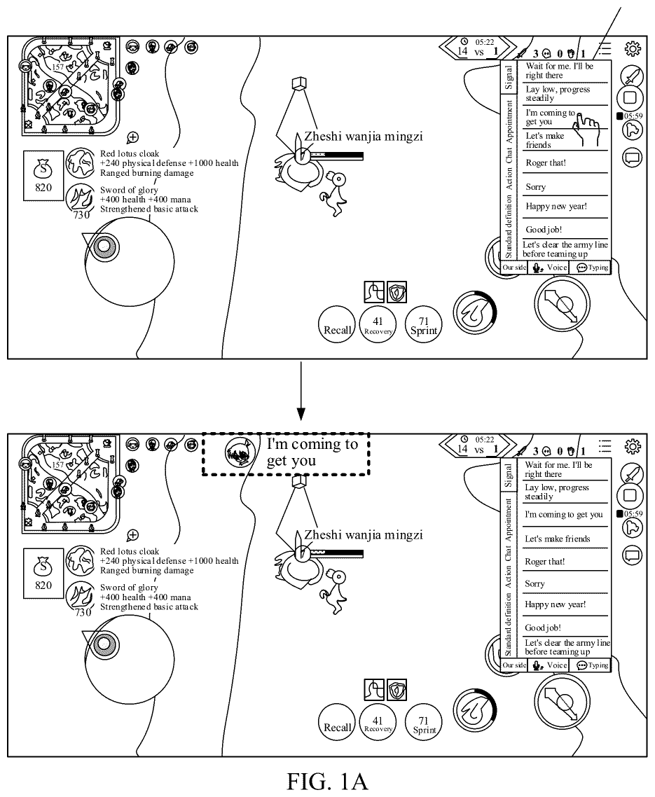

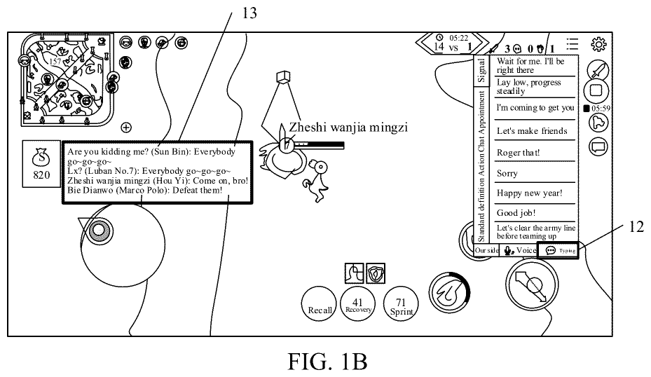

FIG. 1A is a schematic diagram of an example message processing screen in a virtual scene according to the related art. A player object may enter a message selection screen 11 through a message sending control in the screen. The message selection screen 11 provides the player object with a plurality of pieces of fixed message text to be selected, from which the player object selects one and then sends it. As shown in FIG. 1A, when the player object selects “Coming to catch the bad guy” to implement transmission, due to the fixed text in such a message sending manner, the subjective intention of the player object may not be accurately expressed. Consequently, the accuracy of semantic expression is low.

Further, FIG. 1B is a schematic diagram of an example message processing screen in a virtual scene according to the related art. A player object may implement customized editing of a message based on a typing control 12 provided by a message selection screen 11. After being sent, the edited message is displayed in a chat region 13 of an interactive interface. The display of the message in the chat region is ineffective in notifying the player, and the other party needs to perform message editing again for a reply. This makes the communication between player objects in a match inefficient, wasting hardware resources of a device and making hardware resource utilization of the device low.

One or more aspects described herein may provide a message processing system, method, and apparatus, an electronic device, a computer-readable storage medium, and a computer program product, which may implement the editing of a message that comprises a quick reply control and a quick reply to a message in a match, improving the efficiency of communication between virtual objects. Descriptions are provided below separately.

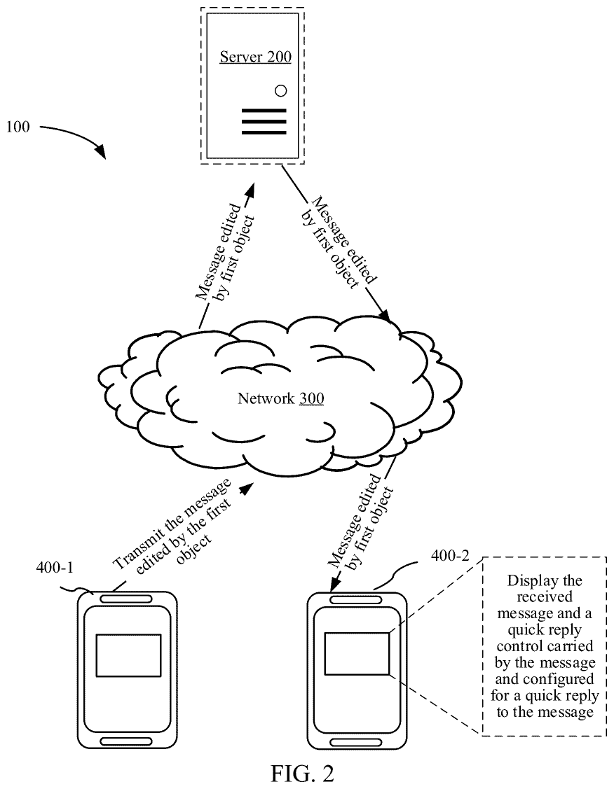

FIG. 2 is a schematic architectural diagram of an example message processing system 100 according to one or more aspects described herein. To support an exemplary application, a terminal 400-1 and a terminal 400-2 may be connected to a server 200 through a network 300. The network 300 may be a wide area network or a local area network, or a combination of the two, using wireless or wired links for data transmission.

The terminal 400-1 of a first player object may be configured to: display and/or cause to be displayed a message control in a matching screen of the first player object in a virtual scene, the message control being configured for editing a message that comprises a quick reply control, the quick reply control being configured for a quick reply to the message; and
transmit, in response to a transmission instruction for a message edited based on the message control, the edited message to the server 200.

The server 200 may be configured to receive the message transmitted by the terminal 400-1 and transmit, to the terminal 400-2 of a second player object, the message transmitted by the terminal 400-1 and received by server 200.

The terminal 400-2 may be configured to: display and/or cause to be displayed a matching screen of the second player object that is in a same match as the first player object; and display and/or cause to be displayed, in the matching screen, the received message and the quick reply control included in the message and configured for a quick reply to the message, wherein the quick reply to the message may be implemented when the second player object triggers the quick reply control.

The message processing method may be implemented by various computer devices, for example, may be implemented by a terminal alone, or may be implemented by a server alone, or may be implemented by a terminal and a server in cooperation. This message processing method may be applied to various scenarios, including but not limited to, a cloud technology, virtual reality, artificial intelligence, smart transportation, assisted driving, game applications, and the like.

The computer devices that implement the message processing method may be various types of terminal devices or servers. The server (such as the server 200) may be an independent physical server, or may be a server cluster or a distributed system comprising a plurality of physical servers, or may be a cloud server that provides basic cloud computing services, such as cloud services, cloud databases, cloud computing, cloud functions, cloud storage, network services, cloud communication, middleware services, domain name services, security services, content delivery networks (CDNs), and big data and artificial intelligence platforms. The terminal (such as the terminal 400-1 and the terminal 400-2) may be a smartphone, a tablet computer, a notebook computer, a desktop computer, an intelligent voice interaction device (such as a smart speaker), a smart home appliance (such as a smart television), a smartwatch, an in-vehicle terminal, or the like, but is not limited thereto. The terminal and the server may be directly or indirectly connected in a wired or wireless communication protocol.

The terminal or the server may run a computer program to implement the message processing method. For example, the computer program may be a native program or a software module in an operating system; or may be a native application (APP), that is, a program that needs to be installed in an operating system to run; or may be a mini program, that is, a program only needs to be downloaded into a browser environment to run; or may be a mini program that can be embedded in any APP. In summary, the foregoing computer program may be any form of application, module, or plug-in.

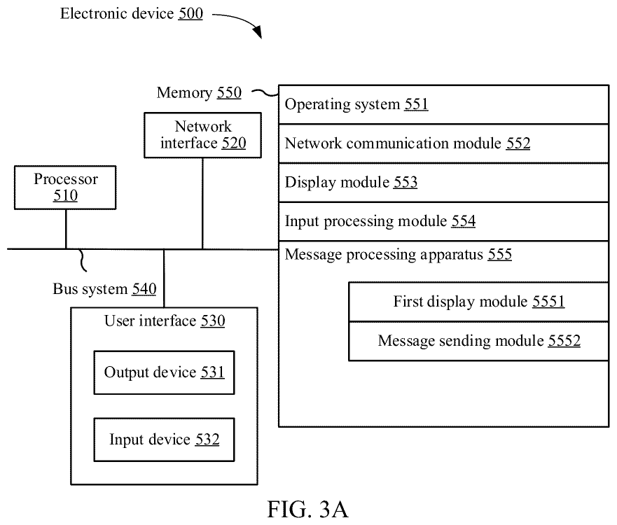

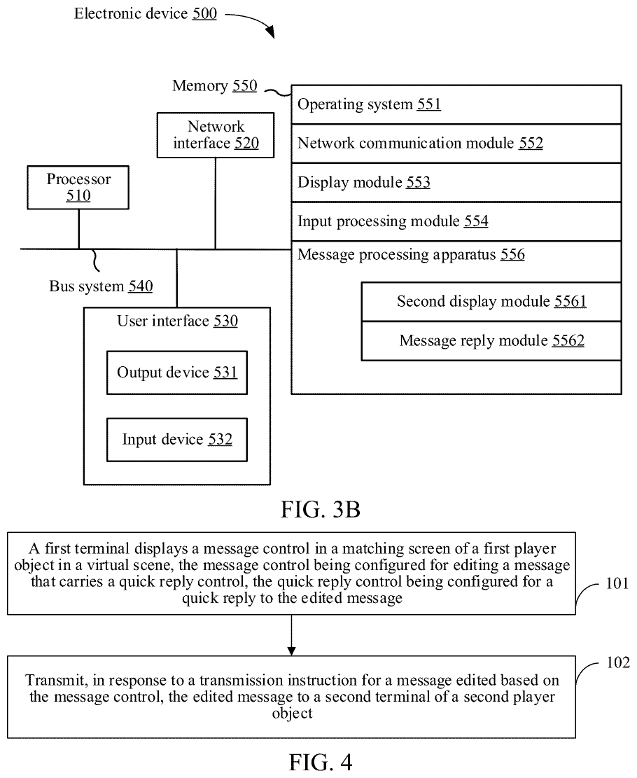

FIG. 3A is a schematic structural diagram of an electronic device 500 that implements a message processing method according to one or more aspects described herein. In an example, the electronic device 500 is the terminal shown in FIG. 2, and may comprise:
at least one processor 510, a memory 550, at least one network interface 520, and a user interface 530. All the components in the electronic device 500 may be coupled together by using a bus system 540. The bus system 540 may be configured to implement connection and communication between the components. In addition to a data bus, the bus system 540 may also include a power bus, a control bus, and a status signal bus. However, for clarity of description, all types of buses in FIG. 3A are marked as the bus system 540.

The processor 510 may be an integrated circuit chip and may have a signal processing capability, for example, a general purpose processor, a digital signal processor (DSP), or another programmable logical device, a discrete gate or a transistor logical device, or a discrete hardware component. The general purpose processor may be a microprocessor, any conventional processor, or the like.

The user interface 530 may include one or more output devices 531 that enable presentation of media content, comprising one or more speakers and/or one or more visual display screens. The user interface 530 may further include one or more input devices 532, comprising a user interface component that facilitates user input, such as a keyboard, a mouse, a microphone, a touchscreen, a camera, and other input buttons and controls.

The memory 550 may be removable, non-removable, or a combination thereof. An exemplary hardware device may include a solid state memory, a hard disk drive, an optical disk drive, or the like. The memory 550 may include one or more storage devices that are physically located away from the processor 510.

The memory 550 may include a volatile memory or a non-volatile memory, or may include both a volatile memory and a non-volatile memory. The non-volatile memory may be a read-only memory (ROM). The volatile memory may be a random access memory (RAM). The memory 550 may include any suitable type of memory.

The memory 550 may store data to support various operations. Examples of the data may include programs, modules, and data structures, or subsets or supersets thereof, as exemplarily described below.

An operating system 551 may include system programs for processing various basic system services and performing hardware-related tasks, such as a framework layer, a kernel library layer, and a drive layer, and may be configured to implement various basic services and process hardware-based tasks.

A network communication module 552 may be configured to reach another computing device through one or more (wired or wireless) network interfaces 520. An example of the network interface 520 may include: Bluetooth, wireless fidelity (WiFi), a universal serial bus (USB), or the like.

A display module 553 may be configured to enable presentation of information through the one or more output devices 531 (such as display screens or speakers) associated with the user interface 530 (for example, a user interface may be configured to operate a peripheral device and display content and information).

An input processing module 554 may be configured to detect one or more user inputs or interactions from the input devices 532 and may translate the detected inputs or interactions.

FIG. 3A shows an example message processing apparatus 555 stored in the memory 550, which may be software in the form of a program, a plug-in, or the like, and may include the following software modules: a first display module 5551 and a message sending module 5552. These modules may be logical and therefore may be arbitrarily combined or split depending on functions implemented. The functions of the modules are described below.

FIG. 3B shows an example message processing apparatus 556 stored in the memory 550, which may be software in the form of a program, a plug-in, or the like, and may comprise the following software modules: a second display module 5561 and a message reply module 5562. These modules may be logical and therefore may be arbitrarily combined or split depending on functions implemented. The functions of the modules are described below.

The message processing apparatus 555 and the message processing apparatus 556 may be additionally and/or alternatively implemented in the form of hardware. For example, the message processing apparatus may be a processor in the form of a hardware decoding processor, which may be programmed to perform the example message processing method described herein. For example, the processor in the form of the hardware decoding processor may use one or more application-specific integrated circuits (ASICs), a DSP, a programmable logic device (PLD), a complex PLD (CPLD), a field-programmable gate array (FPGA), or another electronic element.

Based on the foregoing descriptions of the message processing system and electronic devices, an example message processing method is described herein. The example message processing method described herein may be implemented by a server or a terminal alone, or may be implemented by a server and a terminal in cooperation.

The example message processing method is described below by using an example in which a terminal implements the method. FIG. 4 is a schematic flowchart of an example message processing method according to one or more aspects described herein. The message processing method may comprise one or more of the blocks below.

Block 101: A first terminal may display and/or cause to be displayed a message control in a matching screen of a first player object in a virtual scene, the message control being configured for editing a message that comprises a quick reply control, the quick reply control being configured for a quick reply to the edited message.

For example, a client supporting a virtual scene (such as a game client) may be installed on the first terminal, or the client may be a client that integrates a virtual scene function (such as an instant messaging client, a livestreaming client, or an education client). When a user opens the client on the first terminal and the first terminal runs the client, the user may perform interaction between virtual objects based on a picture of the virtual scene displayed on the client. For example, when the client is a game client, the user may perform interaction (such as virtual battles) between game characters in a game scene based on a game screen displayed on the game client.

For example, a terminal corresponding to the first player object may be the first terminal. The matching screen of the first player object may be a matching screen displayed on the first terminal, that is, a screen displayed on the first terminal and provided for the first player object to have a match when the first player object has the match with another player object based on the first terminal.

A plurality of player objects may be included in the match of the first player object. The plurality of player objects may belong to two teams, for example, a first team and a second team, and each team may comprise at least one player object. The first team and the second team may comprise the same quantity of player objects. The first team and the second team may have an adversarial relationship. It may be assumed that the first player object may be in the first team, the first player object may be in a waiting state (also referred to as “inactive state”), the first team further may comprise at least one second player object in an interactive state (also referred to as “active state”), and the second player object interacts with a player object in the second team. That is, there are at least two second player objects in the interactive state in the match.

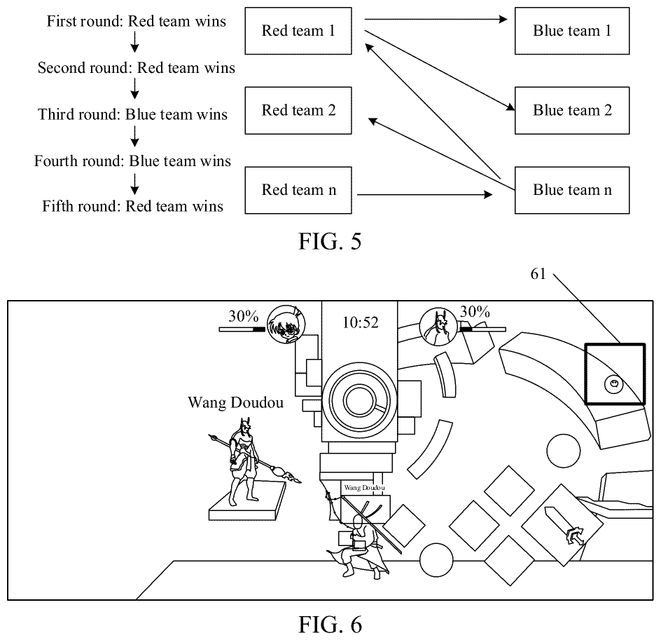

Examples of rules for the interaction between the player objects in the first team and the second team are described herein. In some instances, the first team and the second team may each include n player objects, n being a positive integer greater than or equal to. The first team may be set to a red team, and the player objects in the red team may a red team 1, a red team 2, . . . , and a red team n, respectively. The second team may be set to a blue team, and the player objects in the blue team may a blue team 1, a blue team 2, . . . , and a blue team n, respectively. FIG. 5 is a schematic diagram of an example interaction rule for player objects according to one or more aspects described herein. Round 1 may be the red team 1 versus the blue team 1, that is, the red team 1 and the blue team 1 may be players on the field and may be in the interactive state, and the remaining player objects may be watching “off the field”. If the red team 1 wins in the first round, the second round may be the winning red team 1 versus the blue team 2, the rest can be deduced by analogy, until all player objects in a team die or fail, and the match ends. In other words, the first team may comprise a plurality of (at least two) player objects, and the second team may comprise a plurality of player objects. For each team, at a same time point, there may be one player object in the interactive state and the remaining player objects may be in the waiting state.

In the process of being in the waiting state, when the first player object needs to communicate with the second player object in the interactive state in the first team, because the interaction with the player object in the second team is not required, there is enough time to edit a message. A message with a quick reply function may be edited based on the message control displayed in the matching screen. FIG. 6 is a schematic diagram of an example matching screen according to one or more aspects described herein. Referring to FIG. 6, in the matching screen of the first player object, a battle screen between the second player object in the first team and the second player object in the second team may be displayed, and a message control 61 may be displayed. The first player object may edit, based on the message control 61, a message with a quick reply function for the second player object in the first team.

Block 102: Transmit, in response to a transmission instruction for a message edited based on the message control, the edited message to a second terminal of a second player object.

When the message transmitted by the first terminal is displayed on the second terminal of the second player object, the message comprises a quick reply control, and a quick reply to the message is implemented when the second player object triggers the quick reply control.

Because the message control displayed in the matching screen may be configured for editing a message that comprises a quick reply control, the first player object may edit, based on the message control, the message to be transmitted. In some instances, when the first player object performs a trigger operation (such as clicking/tapping, double-clicking/tapping, or long-pressing) for the message control, the first terminal may display or cause to be displayed a message editing screen in response to the trigger operation for the message control. The first player object may edit the message in the message editing screen. The first terminal may obtain the message edited by the first player object based on the message editing screen, and may display or cause to be displayed a confirm control for the edited message. When the first player object performs a trigger operation (such as clicking/tapping, double-clicking/tapping, or long-pressing) for the confirm control, the first terminal may receive a transmission instruction for the edited message in response to the trigger operation for the confirm control. In this way, the first player object may independently edit by choice a message conforming to the intention of the first player object based on the message editing screen. This improves the accuracy of semantic expression.

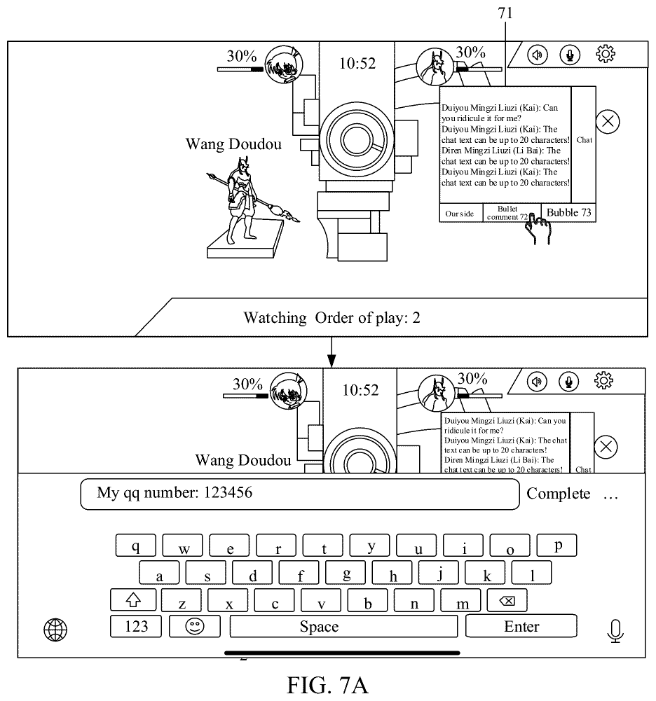

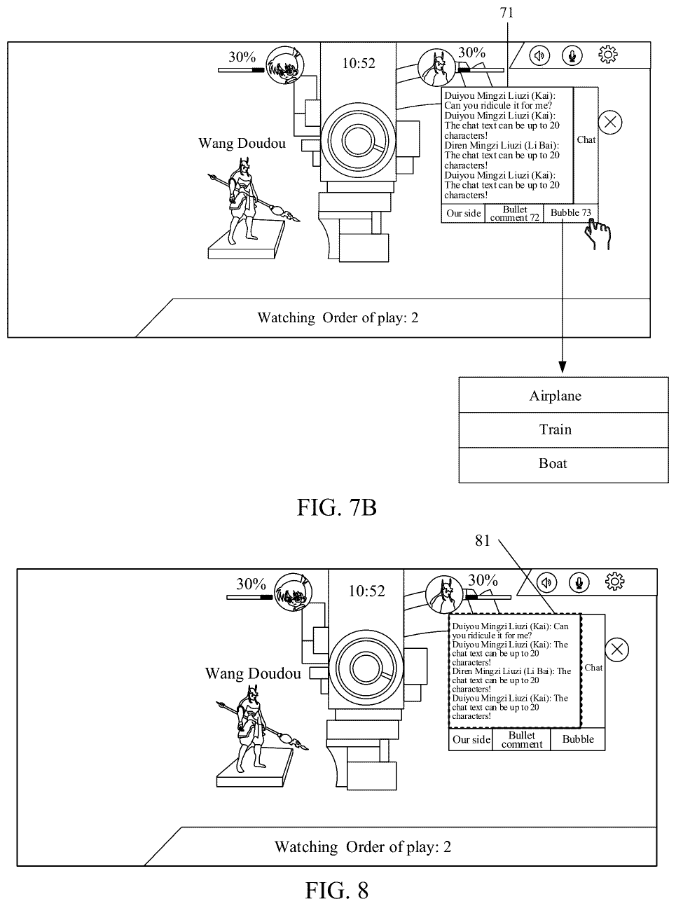

In some instances, the first player object may select a message display manner in the process of message editing based on the message editing screen. For example, after the first player object performs a trigger operation (such as clicking/tapping, double-clicking/tapping, or long-pressing) for the message control 61, a message editing screen may be displayed, and at least two presentation options for indicating message display manners may be displayed in the message editing screen. In response to a target message presentation manner selected based on the at least two presentation options, the target message presentation manner may be determined as a presentation manner of the edited message. FIG. 7A and FIG. 7B are each a schematic diagram of an example screen for selecting a message presentation manner according to one or more aspects described herein. Referring to FIG. 7A, a presentation option 72 corresponding to a bullet comment presentation manner and a presentation option 73 corresponding to a bubble message manner may be displayed in a message editing screen 71. As shown in FIG. 7A, when the first player object selects the presentation option 72 corresponding to the bullet comment presentation manner, a virtual keyboard configured for editing a text message may be called up, and the first player object may edit the message. When the edited message is presented in a matching screen of the second player object, the corresponding presentation manner may be the bullet comment presentation manner.

When the message presentation manner selected by the first player object is the bubble message manner, bubble style options may be provided for the first player object, so that the first player object may select a bubble style. In some instances, when the first player object performs a trigger operation for the presentation option corresponding to the bubble message manner, at least two bubble style options for indicating bubble styles may be displayed or caused to be displayed. In response to a target bubble style selected based on the at least two bubble style options, the target bubble style may be determined as a bubble style of the edited bubble message. For example, referring to FIG. 7B, when the first player object selects the presentation option 73 corresponding to the bubble message manner, three bubble style options may be displayed, which are an airplane, a train, and a boat, respectively. When the first player object selects a bubble style option corresponding to the airplane, the first terminal may use the bubble style corresponding to the airplane as the bubble style of the bubble message edited by the first player object. During the presentation of the bubble message, the bubble message may be in a shape of an airplane, or the bubble message may carry a graphic identifier of an airplane.

In some instances, the first player object may set a reply message corresponding to the edited message. Correspondingly, at least two reply message options may be displayed in the message editing screen, each of the reply message options being corresponding to one reply content for the message. In response to a target reply content selected based on the at least two reply message options, the target reply content may be determined as a reply content corresponding to the message.

Herein, the reply content corresponding to the reply message option may be automatically generated after semantic recognition of the edited message. For example, if the message edited by the first player object based on the message editing screen is “I need backup”, the corresponding automatically generated reply content may be “I'll be right there” or “Can't make it”. When the first player object selects “I'll be right there”, “I'll be right there” may be determined as the reply content corresponding to the edited message. Correspondingly, when the second player object triggers a quick reply based on the quick reply control, the first player object may receive a reply message with the content “I'll be right there”.

The reply content corresponding to the reply message option may alternatively be universal. That is, regardless of the content of the message edited by the first player object, the displayed reply content corresponding to the reply message option may be the same. For example, the reply content may be “Sure” or “OK”. When the reply content corresponding to the reply message option is universal content, different reply message options may correspond to different reply contents. That is, there may be a one-to-one correspondence between reply message options and reply contents. In this way, the first player object may be enabled to set the content of the reply message quickly.

Herein, the first player object may set a plurality of reply contents. That is, the first player object may select two or more reply contents during reply content selection in the message editing screen. In this way, when the message edited by the first player object is transmitted to the second terminal of the second player object, the second terminal not only may display or cause to be displayed the received message, but also may display or cause to be displayed the quick reply control included in the message and a plurality of reply contents corresponding to the message. For example, the plurality of reply contents may be respectively displayed in the form of options. Then, the second player object may implement the quick reply to the message of the first player object after selecting a reply content to be replied with (for example, by clicking/tapping on the option corresponding to the corresponding reply content) and triggering the quick reply control.

In some instances, the first player object may select a message type (such as a voice message or a text message). Correspondingly, the first terminal may display or cause to be displayed, in the message editing screen, at least two message editing controls comprising a target message editing control, different message editing control being corresponding to different message types. A target editing screen of a target message type corresponding to the target message editing control may be displayed in response to a trigger operation for the target message editing control. A message of the target message type that is edited based on the target editing screen may be obtained. For example, the first terminal may display or cause to be displayed a voice message control and a text message control in the message editing screen. When the first player object selects the voice message control, a voice acquisition panel may be called up, and voice message acquisition may be performed based on the voice acquisition panel. When the first player object selects the text message control, a text editing panel may be displayed, the text editing panel comprising a virtual keyboard, and text message editing may be performed based on the text editing panel. This allows the first player object to edit a message of a required type based on a current state thereof. For example, when the first player object is currently in the interactive state, in order to implement quick editing of a message, the voice message control may be selected for voice message editing.

In some instances, a history message region may be further displayed in the message editing screen. In the history message region, a history message transmitted by each player object in the match of the first player object may be displayed. FIG. 8 is a schematic diagram of an example history message presentation screen according to one or more aspects described herein. Referring to FIG. 8, a history message region 81 may be displayed in the message editing screen. A history message transmitted by each player object may be displayed in the history message region 81. In this way, the first player object may be enabled to perform message editing with reference to a history message of each teammate in the first team.

When the message edited by the first player object is a text-type message, there may be a limitation on a character quantity of the message that can be edited by the first player object. The first terminal may obtain, in the message editing screen, the message of the text type that may be input by the first player object, and may count, in real time a quantity of inputted characters. When the character quantity of the inputted message exceeds a character quantity threshold, input prompt information may be displayed, the input prompt information being configured for prompting the input of a text content having a character quantity within the character quantity threshold. For example, the character quantity threshold (which may be set as needed) may be 20. When the character quantity of the message that may be input by the first player object is 21, input prompt information may be displayed, the input prompt information prompting the input of a text message within 20 characters. In this way, the character quantity of the inputted text message may be limited within a particular quantity to ensure that a message length is not extremely long, so that a reader does not need to spend too much time reading the message.

When the first player object completes the editing of the message and a confirm instruction for the edited message may be triggered, the first terminal of the first player object may transmit the edited message to the server, so that the server may forward the message to a terminal of each player object in the match. In some instances, the server may transmit, in a manner of broadcasting, the message to each player object in the first team to which the first player object belongs. That is, the player object in the second team cannot see the message transmitted by the first player object. In this way, the messages in the first team may be isolated from the messages in the second team, ensuring that different team members can view only a message transmitted by a member in their own team, thereby improving the privacy and security of information in message communication between team members.

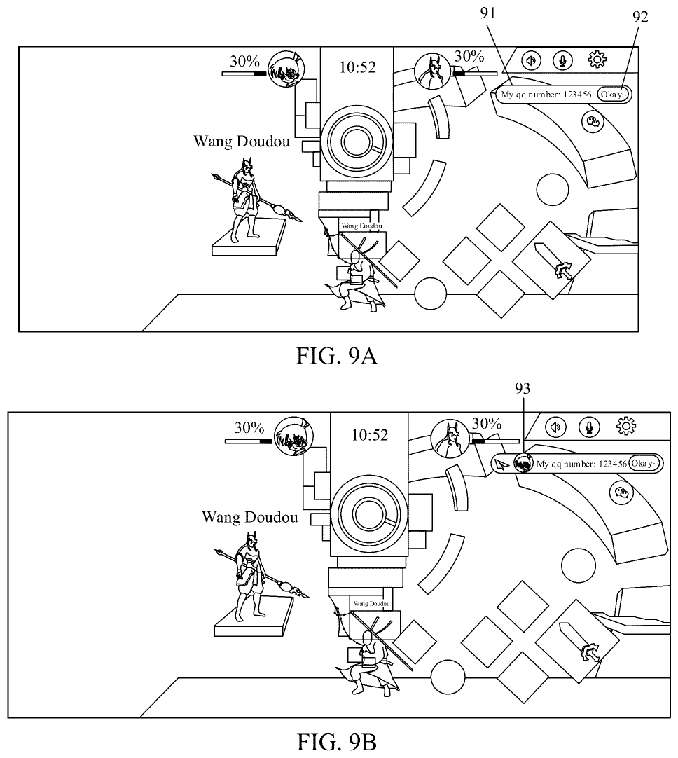

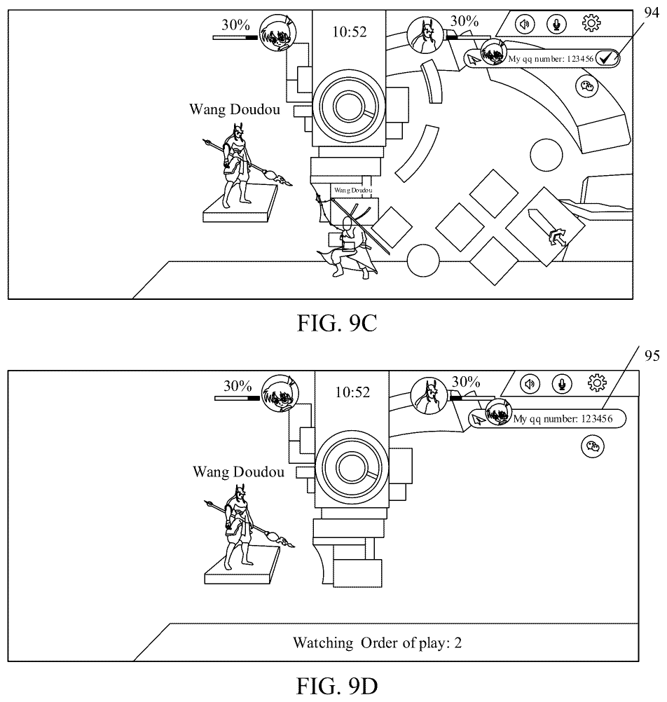

When the second player object in the first team receives the message transmitted by the first player object, the received message may be displayed in a matching screen of the second terminal of the second player object, the message comprising a quick reply control. A reply message corresponding to the message may be transmitted when a trigger operation for the quick reply control is received. FIG. 9A is a schematic diagram of an example message with a quick reply function according to one or more aspects described herein. Referring to FIG. 9A, when the message edited by the first player object is “My qq number: 123456”, the message 91 may be displayed in the matching screen of the second player object. The message may comprise a quick reply control 92. When the second player object performs a trigger operation for the quick reply control 92, the second terminal of the second player object may transmit a reply message corresponding to the message.

In some instances, when the first player object is in a waiting state and the second player object in the first team is in an interactive state, because the attention of the second player object may be focused on an interactive display region, the interactive display region being configured for displaying a picture of interaction between the second player object and another player object, in order to enable the second player object to notice the message transmitted by the first player object, when the second player object in the first team receives the message transmitted by the first player object, the received message may be displayed in a first manner during the interaction between the second player object and the another player object, the first manner being a strong reminder manner. A strong reminder manner is one that uses audio, animation, images (static or dynamic), video and/or the like to provide an enhanced notification to the user of the message so that there is a high likelihood that the user will see the notification. In the examples below, the strong reminder manner may be in the form of bullets or a moving bubble message, but these are merely examples and are not limiting.

The strong reminder manner herein refers to the display of the received message in the interactive display region of the matching screen. In some instances, after the second player object receives the message transmitted by the first player object, the message transmitted by the first player object may be presented in the interactive display region of the matching screen in a bullet comment presentation manner. Alternatively, a process in which a bubble message corresponding to the message crosses the interactive display region may be presented in a bubble message manner, the bubble message comprising an object identifier of the first player object. FIG. 9B is a schematic diagram of an example message with a quick reply function according to one or more aspects described herein. Referring to FIG. 9B, a process in which a bubble message comprising an object identifier 93 moves from one end of the screen to the other and out is presented in the interactive display region of the matching screen. In this way, because the received message may be displayed in the strong reminder manner, the second player object can still notice the message transmitted by the first player object even though the second player object may be in the interactive state. In addition, because the message comprises the object identifier of the first player object, the second player object may be allowed to clearly see the sender of the message. Moreover, because the message comprises a quick reply control, the second player object may be enabled to reply to the message with one click/tap, without affecting the interaction with another player object.

In some instances, a content of the reply message may be displayed on the quick reply control. When the trigger operation for the quick reply control is received, the content displayed on the quick reply control may be transmitted as the content of the reply message. As shown in FIG. 9A, “Okay” may be displayed on the quick reply control 92. After the second player object clicks/taps the quick reply control 92, the second terminal of the second player object may transmit “Okay” as the content of the reply message. In this way, the second player object can implement the quick reply to the message without editing the reply content. To enable the second player object to learn that the message has been replied to, after the second terminal of the second player object transmits the reply message, the second terminal of the second player object may cancel the display of the quick reply control, and may display or cause to be displayed a reply identifier at a display location of the quick reply control, the reply identifier being configured for indicating that a reply to the message is completed.

For example, FIG. 9C is an example schematic diagram of a message with a quick reply function according to one or more aspects described herein. When the second player object clicks/taps on the quick reply control included in the message, the display of the quick reply control may be switched to display of a “check” identifier (reply identifier) 94 to indicate that the message has been read and replied.

When the trigger operation of the second player object for the quick reply control is not received within target duration (for example, three seconds, which may be set according to actual situations), the corresponding second terminal may cancel the display of the message transmitted by the first player object. In this way, the message may not stay in the interactive interface indefinitely to affect the interaction of the second player object.

In a case that the second player object is in the interactive state, in order not to affect the interaction of the second player object with another player object, the second player object cannot edit the message with the quick reply function. That is, although the message control may also be displayed in the matching screen of the second player object, the message control displayed in the matching screen of the second player object may be in an inoperable state. When a state of the second player object switches from the interactive state to the waiting state, a state of the message control may be switched from the inoperable state to an operable state.

The message control displayed in the matching screen of the first player object may be configured for editing a directed message. When the directed message is displayed in a matching screen of a player object in a waiting state in the match, the directed message may be in a non-replyable state, that is, does not include a quick reply control. When displayed in a matching screen of a player object in an interactive state in the match, the directed message comprises a quick reply control.

For example, when the first player object is in the waiting state, after the first terminal of the first player object transmits the edited message, the message may be displayed in the matching screen of the first player object in a strong reminder manner. Because the first player object may be in the waiting state, the message may be in a non-replyable state, that is, does not include a quick reply control. FIG. 9D is a schematic diagram of an example message with a quick reply function according to one or more aspects described herein. Referring to FIG. 9D, when the first player object transmits a message “My qq number: 123456”, the message 95 may be displayed in the interactive display region. The message does not include any quick reply control and may be in a non-replyable state.

In some instances, the message control may be associated with a presentation manner of the message. When the associated presentation manner is a bullet comment presentation manner, a bullet comment corresponding to the message may be presented in an interactive display region of the matching screen of the first player object. That is, the message may be presented in the bullet comment presentation manner. The interactive display region may be configured for displaying a picture of interaction between at least two second player objects in the interactive state. In some instances, when the presentation manner associated with the message control is a bubble message manner, a process in which a bubble message corresponding to the message crosses an interactive display region may be presented in the matching screen of the first player object. The bubble message may comprise an object identifier of the first player object.

When the presentation manner associated with the message control is the bubble message manner, the first player object may set a bubble style. For example, at least two bubble style options for indicating bubble styles may be displayed in the message editing screen. In response to a target bubble style selected based on the at least two bubble style options, the target bubble style may be determined as a bubble style of the bubble message. Correspondingly, after the edited message is transmitted, the first terminal may present, by using the target bubble style, the process in which the bubble message crosses the interactive display region.

In some instances, the message transmitted by the first terminal of the first player object may further include a reply content for the message. For example, after the first player object completes the editing of the message, semantic recognition may be performed on a content of the message to obtain a recognition result. The reply content for the message may be generated based on the recognition result. When a confirm instruction for the edited message is received, the edited message and the reply content may be transmitted, so that when the message is displayed in the matching screen of the second player object, the reply content may be displayed on the quick reply control included in the message, and when the second player object performs a trigger operation for the quick reply control based on the reply content, the first player object may receive the reply content transmitted by the second terminal of the second player object.

In some instances, the message edited by the first player object based on the message control may be a directed message. The directed message may be configured for representing that the message is in a non-replyable state when the message is displayed in a matching screen of a third player object in a waiting state in the match. A quantity of times the first player object transmits the directed message may be limited. After the first player object triggers the confirm instruction for the edited message, the quantity of times the first player object transmits the directed message may be obtained. The edited message may be transmitted when the quantity of times the first player object transmits the directed message does not reach a quantity-of-times threshold (for example, five times, which may be set according to actual needs).

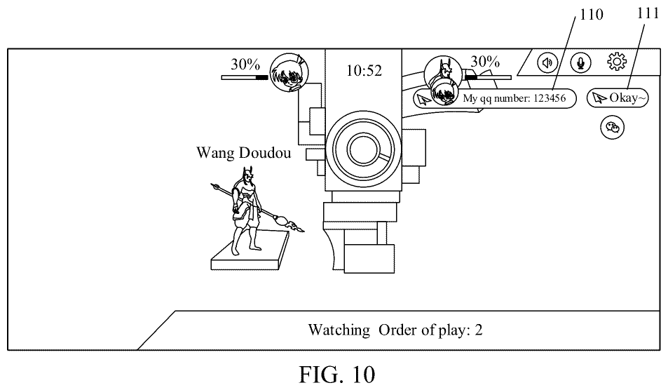

After the second player object makes a one-click/tap reply to the message based on the quick reply control, the first player object may receive the reply message returned by the second player object. For example, the edited message may be displayed in the matching screen. In the process of displaying the message, when the second player object replies to the message based on the quick reply control, the reply content for the message may be displayed in an associated display region of the message. FIG. 10 is a schematic diagram of an example message reply screen according to one or more aspects described herein. Referring to FIG. 10, in the matching screen of the first player object, in an associated display region of an edited message 110 (the end of the message shown in FIG. 10), a reply content 111 for the message may be displayed.

After the first player object edits and transmits the message, when the message is displayed in the matching screen of the second player object in the same match as the first player object, the message may comprise a quick reply control configured for a quick reply to the message. In this way, the second player object may be enabled to implement a quick reply to the message based on the quick reply control included in the message, without the need to edit a reply message. This improves message reply efficiency, communication efficiency with the first player object, and utilization of hardware resources of a device.

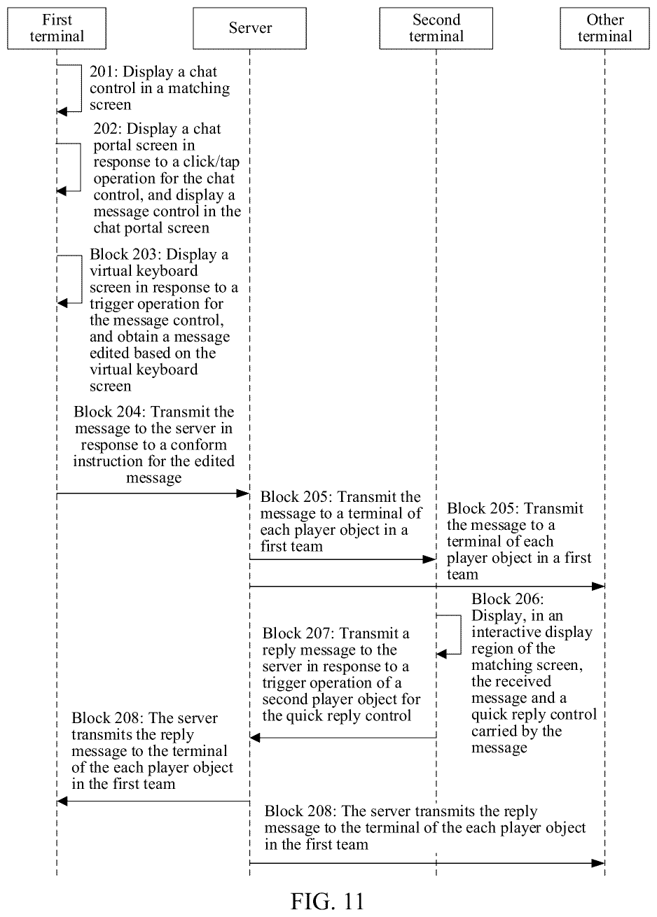

FIG. 11 is a schematic flowchart of an message processing method according to one or more aspects described herein. A first terminal may be a terminal of a first player object. A second terminal may be a terminal of a second player object. The first player object and the second player object may be in a same match. The first player object may be in a waiting state. The second player object may be in an interactive state. The first player object and the second player object may belong to a first team. In a process in which the second player object is in the interactive state, that is, interacts with a player object in a second team, there may be a plurality of player objects in the waiting state in the first team. In some instances, the example message processing method may be implemented by a server or a terminal alone, or may be implemented by a server and a terminal in cooperation. In an example in which the example message processing method is implemented by a server and a terminal in cooperation, referring to FIG. 11, the message processing method may comprise the following blocks:

Block 201: A first terminal displays and/or causes to be displayed a chat control in a matching screen.

Herein, the chat control may be configured for triggering a chat portal.

Block 202: Display and/or cause to be displayed a chat portal screen in response to a click/tap operation for the chat control, and display and/or cause to be displayed a message control in the chat portal screen.

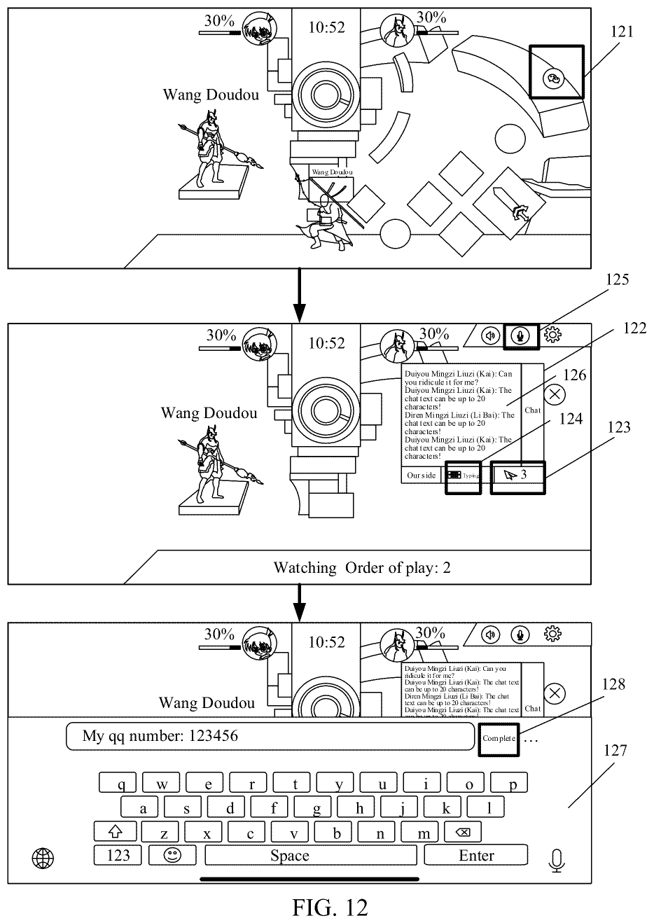

FIG. 12 is a schematic diagram of an example screen of a message processing method according to one or more aspects described herein. Referring to FIG. 12, a chat control 121 may be displayed in the matching screen of the first player object. When the first player object clicks/taps on the chat control 121, the first terminal may display or cause to be displayed a chat portal screen 122 in response to the click/tap operation. A message control 123 configured for editing a message with a quick reply function, a typing control 124, a voice control 125, and a history message region 126 may be displayed in the screen. Next, the different parts of the chat portal screen are described below.

A graphic identifier of a paper airplane carried in the message control 123 may be configured for indicating that the message control may be associated with a presentation manner, and the presentation manner may be a bubble message manner of a paper airplane style. The presentation manner associated with the message control may be set in a settings screen of a virtual scene application. In the settings screen, at least two presentation manners may be provided for a player object to select from. After the player object sets the presentation manner associated with the message control based on the settings screen, the message control displayed in the chat portal screen may comprise a graphic identifier of the corresponding presentation manner. In this way, after the player object transmits a message based on the message control, the message may be presented in the screen in the corresponding presentation style.

The typing control 124 may be configured for editing a regular message. When the player object clicks/taps on the typing control 124, a virtual keyboard may be displayed, causing the player object to edit a content of the message. After the message is edited, the transmission may be triggered, and the message may be displayed in a chat region of the interactive interface (for example, the chat region 13 shown in FIG. 1B).

The voice control 125 may be configured for editing a voice message. When the player object clicks/taps on the voice control 125, a voice acquisition screen may be displayed. The player object may input a voice message based on the voice acquisition screen. After the voice message is edited, the transmission may be triggered, and the message may be presented in the interactive display region in the matching screen in a strong reminder manner.

The history message region 126 may be configured for displaying a history message transmitted by a teammate of the first player object, that is, each player object in the first team. In this way, the first player object may be enabled to perform message editing with reference to the history message of each teammate in the first team.

Block 203: Display and/or cause to be displayed a virtual keyboard screen in response to a trigger operation for the message control, and obtain a message edited based on the virtual keyboard screen.

Still referring to FIG. 12, after the first player object clicks/taps on the message control 123, a virtual keyboard screen 127 may be called up for the first player object to edit the content of the message.

Block 204: Transmit the message to a server in response to a conform instruction for the edited message.

Still referring to FIG. 12, when the first player object clicks/taps on a complete control 128 in the virtual keyboard screen 127, a confirm instruction may be triggered to implement the transmission of the message.

The transmitted message may comprise a message identifier for indicating the message. The message identifier may be configured for indicating that the message has a quick reply function and may be a directed message. The directed message may be configured for representing that the message may be in a non-replyable state when the message is displayed in a matching screen of a player object in a waiting state in the first team, that is, the message does not include a quick reply control. When the message is displayed in a matching screen of a player object in an interactive state in the first team, the message may comprise a quick reply control for a quick reply.

Block 205: The server transmits the message to a terminal of each player object in the first team.

In some instances, the server may parse the message to obtain a message identifier, and then may obtain a reply content corresponding to the message. The reply content may be generated by the server after performing semantic recognition on the content of the message, or may be preset. A message that may comprise the reply content may be transmitted to the second player object, and a message that does not carry the reply content may be transmitted to other player objects in the first team other than the second player object. In this way, a terminal of the second player object may be allowed to display the quick reply control for replying to the message while displaying the message, the quick reply control comprising the reply content. Terminals of the other player objects in the first team other than the second player object may display only the content of the message during the display of the message, and the message may not be replyable.

Block 206: The second terminal may display or cause to be displayed, in an interactive display region of the matching screen, the received message and a quick reply control included in the message.

Because the message control may be associated with the bubble message manner of the paper airplane style after the second terminal receives the message, the message may be displayed by using a bubble message of the paper airplane style. For example, a process in which the bubble message of the paper airplane style crosses the interactive display region may be displayed.

Block 207: Transmit a reply message to the server in response to a trigger operation of a second player object for the quick reply control.

The quick reply control may display or cause to be displayed the reply content for the message. As shown by element 92 in FIG. 9A, when the second player object clicks/taps on the quick reply control, the reply content may be transmitted to the terminal of the first player object.

Block 208: The server transmits the reply message to the terminal of the each player object in the first team.

This example message processing method not only meets a requirement of a player object in a waiting state for accurate editing of a message, but also meets a requirement of the player object in the waiting state for an easy reply to the message and an eye-catching reminder that is not easily missed, without affecting the interaction, thereby improving the efficiency of message communication in the match. In addition, the diversity of message display enhances the fun of social interaction in the match and improves the experience of the player objects.

The message processing method discussed above are described below using an example in which a virtual scene is a game. The game may be a tag team match game. There may be one or rules for the game, which may comprise the rules discussed above with reference to FIG. 5 In the tag team match game, the two teams may play against each other based on the one or more rules of the game (such as those discussed with reference to FIG. 5). Continuing with the example in which the two teams are a red team and a blue team, the red and blue teams may each have a plurality of players waiting “off the field” (that is, in the waiting state). A player whose order of play ranks low may have a longer waiting time, causing easy loss of the player, and increasing needs for communication among team members.

Depending on the rules of the tag team match game, it may be necessary to place different emphasis on the design for players fighting “on the field” (that is, in the interactive state) and players waiting “off the field”. The existing communication function between teammates in mobile games is not designed with features for different situations. Consequently, the existing communication function in the game is limited to the text, phrases, and emoticons set by the system, and refined communication cannot be achieved.

In the tag team match game, waiting players may customize the text with a limited quantity of words if necessary. The players can transmit battle skills, chaffing, satirizing, praising, and other content to enhance the interaction between the players, and transmit such information to a screen focus region, so that the players fighting on the field can immediately see this information and quickly click/tap to reply.

This solution may be specifically designed for different situations of players on the field and players off the field in the tag team match game: The players off the field have a higher degree of freedom and more waiting time as spectators, and use the waiting time for typing and editing to accurately express the desired content. The players on the field fight fiercely and do not have enough time to type replies. Therefore, the design may be to click/tap on a button to reply with an emoticon “Roger that/Got it/OK” and other relatively generalized content. This meets different demands of different players, improves the accuracy of the information obtained by the players, avoids ineffective communication, and increases communication efficiency. In addition, during presentation, the message may float across the interactive display region as a bullet comment, or cross the interactive display region as a paper airplane. This increases the fun of game social interaction and improves the user experience.

In another example, the player object in the waiting state may be the player off the field (waiting for the battle), and the player object in the interactive state may be the player on the field (in the battle). Each player waiting “off the field” may have n (n is a positive integer, and can be set according to actual needs) opportunities to customize the content of the message and broadcast it to the whole team. A chat button (for example, 121 in FIG. 12) may be displayed in a battle screen (that is, the matching screen). When the player off the field clicks/taps on the chat button, the chat panel (for example, 122 in FIG. 12) may be displayed. After the player clicks/taps on a text editing button (that is, the message control, for example, 123 in FIG. 12), a mobile phone keypad (for example, 127 in FIG. 12) may be called up. After the player off the field edits the text and clicks/taps on a “Complete” key on the keypad, the message may be transmitted. The message may be transmitted to each member of the same team, that is, it may be visible to all members of our team but cannot be viewed by the enemy (such as players of the opposing team).

After a player on the field in the team receives a broadcast message, the message may float across the interactive display region (the center region of the battle screen) in the form of a bullet comment, or may cross the interactive display region as a paper airplane, which may appear from one side (for example, the right side) of the interactive display region and then move to the other side of the interactive display region to disappear. Different from the content seen by the player off the field, the end of the message displayed on the terminal of the player on the field may be accompanied by a one-click/tap reply button (as shown by 92 in FIG. 9A). The message can be accurately replied to by clicking/tapping the button, and the content of the reply may be the content displayed on the button.

If the player does not perform any operation, the message may automatically disappear after appearing for a period of time (for example, three seconds). That is, the terminal may stop or cancel the display of the message after a period of time in a case that the terminal does not receive a click/tap operation for the one-click/tap reply button. If the player on the field clicks/taps on the button to reply with one click/tap, the player may see the message showing a status of “Replied”. That is, the terminal may switch the displayed button to display of a read indicator to indicate that the message has been read and replied to. As shown by 94 in FIG. 9C, the button may change to a “check mark” to indicate that it has been read and replied to. Correspondingly, after the player off the field receives the reply from the player on the field, the content of the reply from the player on the field may be displayed in the associated display region of the message. For example, a corresponding bubble (as shown by 111 in FIG. 10) may pup up at the end of the message just transmitted to represent that the reply is to this broadcast message.

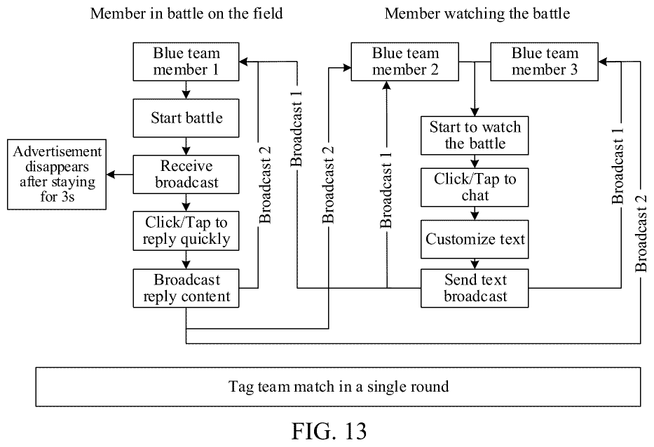

Based on the foregoing description of the display screen of each player terminal in the tag team match game, an example interaction between the player objects in the same team is illustrated next by using the blue team as an example. FIG. 13 is a schematic diagram of an example player interaction in a tag team match game according to one or more aspects described herein. Referring to FIG. 13, the blue team consists of three members, with a blue team member 1 in combat, and a blue team member 2 and a blue team member 3 waiting for combat, that is, in a spectator state. When a member of the blue team watching the match customizes text and transmits it based on the text editing button in the chat panel, the edited message may be transmitted to each member of the blue team through broadcast 1. Only the blue team member 1 can reply to the broadcast message transmitted to each member. That is, the one-click/tap reply button may be displayed on the terminal of the blue team member 1. Other members watching the game cannot reply, that is, the terminals of other members watching the game do not carry a one-click/tap reply button during display. When the blue team member 1 clicks/taps the one-click/tap reply button, a quick reply to the broadcast message may be implemented. The content of the reply may also be broadcasted and transmitted to each member of the blue team through broadcast 2.

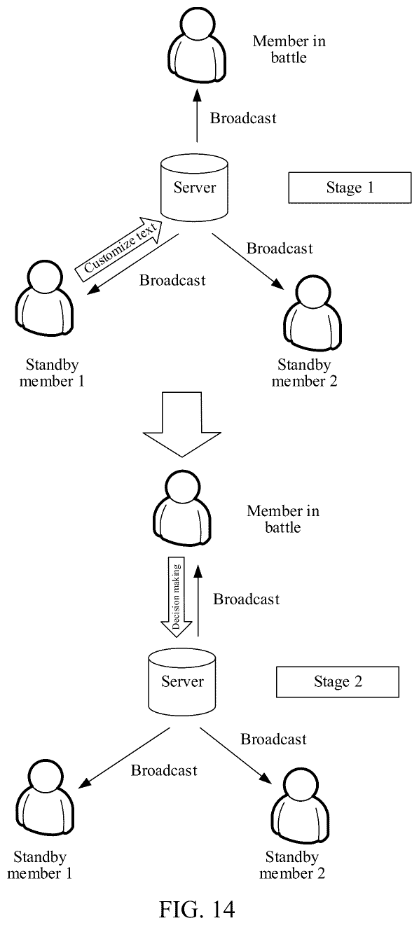

Herein, the broadcast of the above messages may be implemented by the server. FIG. 14 is a schematic diagram of an example of message broadcasting by a server according to one or more aspects described herein. Referring to FIG. 14, at a first stage, a player off the field may transmit a customized broadcast message to a server. After the player off the field transmits the customized text to the server, the server transmits the message to each member of the team through broadcast. At a second stage, that is, a stage at which players on the field make decisions (one-click/tap reply), when a player on the field clicks/taps on the reply button carried in the message to reply with one click/tap, the server may transmit the reply content to each member of the team through a broadcast message.

Next, an example of the transmission of the message is described. The client may perform an operation to encapsulate the text content into a protocol packet and may transmit it to the server through a TCP (a connection-oriented, reliable, byte stream-based transport layer communication protocol) request. After receiving the protocol packet, the server may notify the member of a reply packet to inform that the feedback of the protocol packet has been received. Then, the server may use a decoder to parse and process the packet into a response packet, and may broadcast it to clients of other members of the team through the network. Only members in the battle can make corresponding decisions and reply after receiving the request packet. Players waiting have no decision-making function, that is, they cannot reply to the message and can only watch. When a member in the battle clicks/taps on the reply button to reply to the message, the client may encapsulate the decision corresponding to the member in the battle into a protocol packet and may transmit it to the server. After receiving the protocol packet, the server may use a decoder to parse and process the protocol packet into a response packet (comprising the reply content), and may broadcast it to all members of the team.

In some instances, the broadcast text that can be customized and edited may be specifically transmitted to a particular member, and the member may reply with one click/tap. This satisfies the different demands of different players under the gameplay, improves the accuracy of information obtained by the players, avoids ineffective communication, and increases the communication efficiency. In addition, diversified processing may be performed in the form of presentation, such as floating through as a bullet comment, or crossing through as a paper airplane. This increases the fun of game social interaction and enhances the user experience.

In one example, the message processing apparatus 555 may be implemented as a software module. In some instances, the message processing apparatus include a first display module 5551 and a message sending module 5552.

The first display module 5551 may be configured to display and/or cause to be displayed a message control in a matching screen of a first player object in a virtual scene, the message control being configured for editing a message that comprises a quick reply control, the quick reply control being configured for a quick reply to the message.

The message sending module 5552 may be configured to transmit, in response to a transmission instruction for a message edited based on the message control, the edited message to a second player object, the message comprising the quick reply control when the message is displayed on a terminal of the second player object, and the quick reply to the message being implemented when the second player object triggers the quick reply control.

The message processing apparatus may further comprise: a message editing module 5553.

The message editing module 5553 may be configured to display and/or cause to be displayed a message editing screen in response to a trigger operation for the message control, obtain a message edited by the first player object based on the message editing screen, and display and/or cause to be displayed a confirm control for the message.

The message sending module 5552 may be further configured to receive the transmission instruction in response to a trigger operation for the confirm control, and transmit the edited message to a second terminal of the second player object.

In the match, the first player object may be in a waiting state, and the second player object may be in an interactive state.

The first display module may be further configured to display and/or cause to be displayed the message in the matching screen of the first player object in a strong reminder manner, the message being in a non-replyable state.

The message editing module may be further configured to display and/or cause to be displayed, in the message editing screen, at least two presentation options for indicating message presentation manners; and
determine, in response to a target message presentation manner selected based on the at least two presentation options, the target message presentation manner as a presentation manner of the message.

The first display module may be further configured to display and/or cause to be displayed the message in the target message presentation manner in the matching screen.

The message control may be associated with a presentation manner of the message.

The first display module may be further configured to present a bullet comment corresponding to the message in an interactive display region of the matching screen when the presentation manner associated with the message control may be a bullet comment presentation manner,
the interactive display region being configured for displaying a picture of interaction between at least two second player objects.

The first display module may be further configured to: when the presentation manner associated with the message control is a bubble message manner, present, in the matching screen of the first player object, a process in which a bubble message corresponding to the message crosses an interactive display region,
the bubble message comprising an object identifier of the first player object, and the interactive display region being configured for displaying a picture of interaction between at least two second player objects.

The message editing module may be further configured to display and/or cause to be displayed, in the message editing screen, at least two bubble style options for indicating bubble styles; and
determine, in response to a target bubble style selected based on the at least two bubble style options, the target bubble style as a bubble style of the bubble message.

The first display module may be further configured to display and/or cause to be displayed, by using the target bubble style, the process in which the bubble message crosses the interactive display region.

The message editing module may be further configured to display and/or cause to be displayed at least two reply message options in the message editing screen, each of the reply message options being corresponding to one reply content for the message; and
determine, in response to a target reply content selected based on the at least two reply message options, the target reply content as a reply content corresponding to the message.

The first display module may be further configured to display and/or cause to be displayed the target reply content when the second player object performs a trigger operation for the quick reply control.

A reply content for the message may be displayed in the quick reply control.

The first display module may be further configured to: when the second player object performs a trigger operation for the quick reply control based on the reply content, receive the reply content transmitted by the terminal of the second player object; and
display and/or cause to be displayed the reply content of the second player object for the message.

The message editing module may be further configured to: after the message edited by the first player object based on the message editing screen is obtained, perform semantic recognition on a content of the message to obtain a recognition result; and
generate the reply content for the message based on the recognition result.

The message sending module may be further configured to transmit the edited message and the reply content in response to a confirmation instruction for the edited message, so that the reply content is displayed in the quick reply control carried in the message when the message is displayed in the matching screen of the second player object.

The message editing module may be further configured to display and/or cause to be displayed at least two message editing controls comprising a target message editing control in the message editing screen, different message editing controls being corresponding to different message types;
display and/or cause to be displayed a target editing screen of a target message type corresponding to the target message editing control in response to a trigger operation for the target message editing control; and
obtain a message of the target message type that is edited based on the target editing screen.

The message editing module may be further configured to display and/or cause to be displayed a history message region in the message editing screen; and
display and/or cause to be displayed, in the history message region, a history message transmitted by each player object in the match of the first player object.

The message editing module may be further configured to obtain, in the message editing screen, a message of a text type that may be input by the first player object; and
display and/or cause to be displayed input prompt information when a character quantity of the inputted message exceeds a character quantity threshold, the input prompt information being configured for prompting the input of a text content having a character quantity within the character quantity threshold.

The message may be a directed message, and the directed message may be configured for representing that the message may be in a non-replyable state when the message is displayed in a matching screen of a third player object in a waiting state in the match.

The message sending module may be further configured to obtain, in response to a confirmation instruction for the edited message, a quantity of times the first player object transmits the directed message; and
transmit the edited message when the quantity of times the first player object transmits the directed message does not reach a quantity-of-times threshold.

The message sending module may be further configured to transmit the edited message to a server in response to a confirmation instruction for the edited message, so that the server transmits the message to a player object that may be in a same team as the first player object in the match.

The first display module may be further configured to display and/or cause to be displayed the message in the matching screen; and
in the process of displaying the message, when the second player object replies to the message based on the quick reply control, display and/or cause to be displayed the reply content for the message in an associated display region of the message.

The first display module may be further configured to: in the matching screen, display and/or cause to be displayed the message and obtain display duration of the message; and
cancel the display of the message when the display duration reaches a duration threshold and the second player object does not reply to the message.

The message processing apparatus 556 referenced above may comprise:
a second display module 5561, configured to display and/or cause to be displayed, in a matching screen of a second player object, a message transmitted by a first player object that may be in a same match as the second player object, the message comprising a quick reply control; and
a message reply module 5562, configured to transmit a reply message corresponding to the message when a trigger operation for the quick reply control is received.

In some instances, in the match, the first player object may be in a waiting state, and the second player object may be in an interactive state.

The second display module may be further configured to: in a process of interaction between the second player object and another player object, display and/or cause to be displayed, in the matching screen in a strong reminder manner, the message transmitted by the first player object.

The second display module may be further configured to display and/or cause to be displayed, in an interactive display region of the matching screen, the message transmitted by the first player object,
the interactive display region being configured for displaying a picture of the interaction between the second player object and the another player object.

The second display module may be further configured to present, in the interactive display region of the matching screen in a bullet comment presentation manner, the message transmitted by the first player object; or
present, in a bubble message manner, a process in which a bubble message corresponding to the message crosses the interactive display region, the bubble message comprising an object identifier of the first player object.

In some instances, a content of the reply message may be displayed on the quick reply control.

The message reply module may be further configured to: when the trigger operation for the quick reply control is received, transmit the content displayed on the quick reply control as the content of the reply message.

The second display module may be further configured to cancel display of the quick reply control, and display and/or cause to be displayed a reply identifier at a display location of the quick reply control,
the reply identifier being configured for indicating that a reply to the message is completed.

The second display module may be further configured to: when the trigger operation for the quick reply control is not received within target duration, cancel the display of the message transmitted by the first player object.

The first player object may be in a waiting state, and the second player object may be in an interactive state.

The second display module may be further configured to display and/or cause to be displayed a message control in the matching screen of the second player object, the message control being in an inoperable state, and
the message control being configured for editing a directed message, the directed message being in a non-replyable state when the directed message is displayed in a matching screen of a player object in a waiting state in the match, and the directed message comprising the quick reply control when the directed message is displayed in a matching screen of a player object in an interactive state in the match; and
when a state of the second player object switches from the interactive state to the waiting state, switch a state of the message control from the inoperable state to an operable state.

One or more aspects described herein further provides an electronic device, comprising:
one or more processors; and
a memory, configured to store computer-readable instructions that when executed by the one or more processors, causes the electronic device to implement the message processing method.

One or more aspects described herein further provides a computer program product or a computer program. The computer program product or the computer program may comprise computer instructions, and the computer instructions are stored in a computer-readable storage medium. One or more processors of a computer device reads the computer instructions from the computer-readable storage medium and executes the computer instructions to cause the computer device to perform the message processing method.

One or more aspects described herein further provides a non-transitory computer-readable storage medium, storing executable instructions, the executable instructions, when executed by one or more processors, implements the message processing method.

The non-transitory computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disc, or a CD-ROM; or may be various devices comprising one of or any combination of the foregoing memories.

The executable instructions may be written in the form of a program, software, a software module, a script, or code in any form of programming language (including complied or interpreted languages, or declarative or procedural languages), and may be deployed in any form, including being deployed as a stand-alone program or deployed as a module, a component, a subroutine, or other units suitable for use in a computing environment.

In an example, the executable instructions may, but do not necessarily, correspond to a file in a file system, and may be stored in part of a file that holds other programs or data, for example, stored in one or more scripts in a Hyper Text Markup Language (HTML) document, or in a single file specifically used for the program under discussion, or in a plurality of collaborative files (for example, files storing one or more modules, subprograms, or code sections).

In an example, the executable instructions may be deployed on one computing device for execution, or on a plurality of computing devices located at a same place for execution, or on a plurality of computing devices distributed across a plurality of places and connected through a communication network for execution.

The foregoing descriptions are not intended to limit the protection scope of this application. Any modification, equivalent replacement, or improvement made without departing from the spirit and scope of this application shall fall within the protection scope of this application.

What is claimed is:

1. A method comprising:
causing to be displayed, by a first terminal device, a message control in a first screen of a first player object in a virtual scene, the message control being configured for editing a message that comprises a quick reply control, the quick reply control being configured for a quick reply to the message; and
transmitting, in response to a transmission instruction for an edited message that has been edited by the first player object using the message control, the edited message to a second terminal device associated with a second player object,
wherein the edited message comprises the quick reply control when displayed on the second terminal device displaying a second screen matching the first screen, and
wherein a reply message is generated using the quick reply control when the second player object triggers the quick reply control.

2. The method according to claim 1, further comprising:
causing to be displayed, by the first terminal device and in response to a trigger operation for the message control, a message editing screen;
obtaining the edited message edited by the first player object using the message editing screen of the message control;
causing to be displayed a confirm control for the edited message; and
receiving the transmission instruction in response to a trigger operation for the confirm control.

3. The method according to claim 2, further comprising:
causing to be displayed, in the message editing screen, at least two presentation options for presenting the edited message; and
determining, in response to a target message presentation manner selected based on the at least two presentation options, the target message presentation manner as a presentation manner of the edited message,
wherein the edited message is presented in the second screen of the second terminal device that matches the first screen of the first terminal device and in the target message presentation manner.

4. The method according to claim 1, wherein the first player object is in inactive state, and the second player object is in an active state comprising interacting with one or more other player objects, further comprising
causing to be displayed, in the first screen of the first player object and in a first manner, the edited message, wherein the edited message is displayed in a non-replyable state.

5. The method according to claim 4, wherein the message control is associated with a presentation manner of the message, and the displaying the message in the first screen of the first player object in a first manner comprises:
presenting a bullet comment corresponding to the message in an interactive display region of the first screen based on determining that the presentation manner associated with the message control is a bullet comment presentation manner,
wherein the interactive display region is configured for displaying a picture of interaction between at least two second player objects.

6. The method according to claim 4, wherein the message control is associated with a presentation manner of the message, and the displaying the message in the first screen of the first player object in a first manner comprises:
based on determining that the presentation manner associated with the message control is a bubble message manner, presenting, in the first screen of the first player object, a process in which a bubble message corresponding to the message crosses an interactive display region,
wherein the bubble message comprises an object identifier of the first player object, and
wherein the interactive display region is configured for displaying a picture of interaction between at least two second player objects.

7. The method according to claim 6, further comprising:
causing to be displayed at least two bubble style options for indicating bubble styles; and
determine, in response to a target bubble style selected based on the at least two bubble style options, the target bubble style as a bubble style of the bubble message.

8. The method according to claim 2, further comprising:
displaying at least two reply message options in the message editing screen, each of the reply message options being corresponding to one reply content for the edited message; and
determining, in response to a target reply content selected based on the at least two reply message options, the target reply content as a reply content corresponding to the edit message.

9. The method according to claim 1, wherein a reply content for the edited message is displayed in the quick reply control, the method further comprising:
responsive to the second player object performing a trigger operation for the quick reply control based on the reply content, receiving the reply content transmitted by the second terminal device of the second player object; and
causing to be displayed the reply content of the second player object for the edited message.

10. The method according to claim 9, further comprising:
performing semantic recognition on a content of the message to obtain a recognition result; and
generating the reply content for the message based on the recognition result,
wherein the transmitting the edited message to a second terminal device of a second player object comprises transmitting the edited message and the reply content to the second terminal device of the second player object,
wherein the reply content is displayed in the quick reply control included in edited the message when the edited message is displayed in the second screen of the second player object.

11. The method according to claim 2, wherein the obtaining a message edited by the first player object based on the message editing screen comprises:
causing to be displayed at least two message editing controls comprising a target message editing control in the message editing screen, wherein each message editing control corresponds to a different message type;
causing to be displayed a target editing screen of a target message type corresponding to the target message editing control in response to a trigger operation for the target message editing control; and
obtaining a message of the target message type that is edited based on the target editing screen.

12. The method according to claim 1, further comprising:
causing to be displayed a history message region; and
causing to be displayed, in the history message region, a history message transmitted by each player object in a match of the first player object.

13. The method according to claim 2, wherein the obtaining a message edited by the first player object based on the message editing screen comprises:
obtaining, in the message editing screen, a message of a text type that is input by the first player object; and
causing to be displayed input prompt information in response to determining that a character quantity of the message exceeds a character quantity threshold, the input prompt information being configured for prompting input of a text content having a character quantity within the character quantity threshold.

14. The method according to claim 1, wherein:
the edited message is a directed message,
the directed message is configured for representing that the edited message is in a non-replyable state when the edited message is displayed in a matching screen of a third player object in an inactive state in a match, and
the transmitting the edited message to a second terminal of a second player object comprises:
obtaining a quantity of times the first player object transmits the directed message; and
transmitting the edited message to the second terminal of the second player object in response to determining that the quantity of times the first player object transmits the directed message does not reach a quantity-of-times threshold.

15. The method according to claim 1, wherein the transmitting the edited message to a second terminal device of a second player object comprises:
transmitting the edited message to a server, the server being configured to transmit the edited message to the second terminal device of the second player object,
wherein the second player object is a player object that is in a same team as the first player object in a match.

16. The method according to claim 1, wherein after the transmitting the edited message to a second terminal device of a second player object, the method further comprises:
displaying the edited message in the first screen; and
based on the second player object replying to the edited message based on the quick reply control, causing to be displayed reply content for the edited message in an associated display region of the edited message.

17. The method according to claim 1, wherein after the transmitting the edited message to a second terminal device of a second player object, the method further comprises:
causing to be displayed the edited message on the first screen;
obtaining a display duration of the edited message on the first screen; and
canceling display of the edited message on the first screen when the display duration reaches a duration threshold and the second player object does not reply to the edited message.

18. A non-transitory computer readable medium storing instructions which, when executed by one or more processors, cause the one or more processors to:
cause to be displayed, by a first terminal device, a message control in a first screen of a first player object in a virtual scene, the message control being configured for editing a message that comprises a quick reply control, the quick reply control being configured for a quick reply to the message; and
transmit, in response to a transmission instruction for an edited message that has been edited by the first player object using the message control, the edited message to a second terminal device associated with a second player object,
wherein the edited message comprises the quick reply control when displayed on the second terminal device displaying a second screen matching the first screen, and
wherein a reply message is generated using the quick reply control when the second player object triggers the quick reply control.

19. The non-transitory computer readable medium according to claim 18, further storing instructions which, when executed by the one or more processors, cause the one or more processors to:
cause to be displayed, by the first terminal device and in response to a trigger operation for the message control, a message editing screen;
obtain the edited message edited by the first player object using the message editing screen of the message control;
cause to be displayed a confirm control for the edited message; and
receive the transmission instruction in response to a trigger operation for the confirm control.

20. A system comprising:
a first terminal device; and
a second terminal device,
wherein the first terminal device is configured to:
cause to be displayed a message control in a first screen of a first player object in a virtual scene, the message control being configured for editing a message that comprises a quick reply control, the quick reply control being configured for a quick reply to the message; and
transmit, in response to a transmission instruction for an edited message that has been edited by the first player object using the message control, the edited message to a second terminal device associated with a second player object, and
wherein the second terminal device is configured to:
cause to be displayed, on a second screen matching the first screen, an edited message comprising the quick reply control, and
generate a reply message using the quick reply control when the second player object triggers the quick reply control.
